(19) United States
(12) Patent Application Publication
(10) Pub. No.: US 2006/0067348 A1
(43) Pub. Date: Mar. 30, 2006

(54) System and method for efficient memory access of queue control data structures

(76) Inventors: Sanjeev Jain, Shresbury, MA (US); Gilbert M. Wolrich, Framingham, MA (US); Mark B. Rosenbluth, Uxbridge, MA (US)

Correspondence Address: DALY, CROWLEY & MOFFORD, LLP, C/O PORTFOLIOIP, P. O. BOX 52050, MINNEAPOLIS, MN, 55402, US

(21) Appl. No.: 10/955,936

(22) Filed: Sep. 30, 2004

(51) Int. Cl. H04L 12/28

(52) U.S. Cl. 370/412

(57) ABSTRACT

A system that queues data packets includes efficient memory access of queue control data structures.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, network devices, such as routers and switches, can include network processors to facilitate receiving and transmitting data. In certain network processors, such as IXP Network Processors by Intel Corporation, high-speed queuing and FIFO (First In First Out) structures are supported by a descriptor structure that utilizes pointers to memory. U.S. Patent Application Publication No. U.S. 2003/0140196 A1 discloses exemplary queue control data structures. Packet descriptors that are addressed by pointer structures may be 32-bits or less, for example.

Adding a 32-bit entry to a linked list or FIFO is relatively inefficient for memory systems with a 64-bit minimum access. When adding an entry to a FIFO, a 64-bit write is needed for the first 32-bit entry of a 64-bit aligned pair, and a 64-bit read-modify-write is required to insert the second 32-bit entry of the same 64-bit aligned pair. When removing a 32-bit entry a 64-bit read access is required. Thus, to add two 32-bit entries to a queue requires a 64-bit write, and a 64-bit read-modify-write. To remove the entries one at a time requires two 64-bit read operations. The read-modify-write not only uses extra bandwidth, but also requires additional latency and complexity.

### BRIEF DESCRIPTION OF THE DRAWINGS

The exemplary embodiments contained herein will be more fully understood from the following detailed description taken in conjunction with the accompanying drawings, in which:

FIG. 1 is a diagram of an exemplary system including a network device having a network processor unit with a mechanism to avoid memory back conflicts when accessing queue descriptors;

FIG. 2 is a diagram of an exemplary network processor having processing elements with a conflict-avoiding queue descriptor structure;

FIG. 3 is a diagram of an exemplary processing element (PE) that runs microcode;

FIG. 4 is a diagram showing an exemplary data queuing implementation;

FIG. 5 is a diagram showing an exemplary queue descriptor structure;

FIG. 5A is a diagram showing an exemplary memory block;

FIG. 6 is a diagram showing an exemplary queue descriptor as commands are received;

FIG. 7 is a diagram showing an exemplary queue descriptor pointing a last block location for an insert command;

FIG. 8 is a diagram showing an exemplary queue descriptor pointing at a last block location for a remove command;

FIG. 9 is a flow diagram showing an exemplary implementation of a queue descriptor structure for insert operations;

FIG. 10 is a flow diagram showing an exemplary implementation of a queue descriptor structure for remove operations;

### DETAILED DESCRIPTION

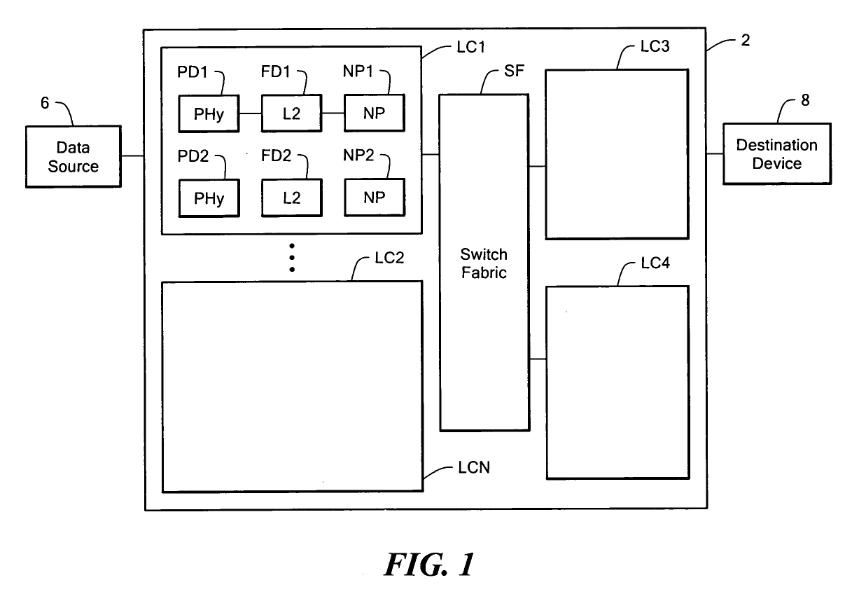

FIG. 1 shows an exemplary network device 2 having network processor units (NPUs) utilizing queue control structures with efficient memory accesses when processing incoming packets from a data source 6 and transmitting the processed data to a destination device 8. The network device 2 can include, for example, a router, a switch, and the like. The data source 6 and destination device 8 can include various network devices now known, or yet to be developed, that can be connected over a communication path, such as an optical path having a OC-192 line speed.

The illustrated network device 2 can manage queues and access memory as described in detail below. The device 2 features a collection of line cards LC1-LC4 (“blades”) interconnected by a switch fabric SF (e.g., a crossbar or shared memory switch fabric). The switch fabric SF, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., LC1) may include one or more physical layer (PHY) devices PD1, PD2 (e.g., optic, wire, and wireless PHYs) that handle communication over network connections. The PHYs PD translate between the physical signals carried by different network mediums and the bits (e.g., “0”-s and “1”-s) used by digital systems. The line cards LC may also include framer devices (e.g., Ethernet, Synchronous Optic Network (SONET), High-Level Data Link (HDLC) framers or other “layer 2” devices) FD1, FD2 that can perform operations on frames such as error detection and/or correction. The line cards LC shown may also include one or more network processors NP1, NP2 that perform packet processing operations for packets received via the PHY(s) and direct the packets, via the switch fabric SF, to a line card LC providing an egress interface to forward the packet. Potentially, the network processor(s) NP may perform “layer 2” duties instead of the framer devices FD.

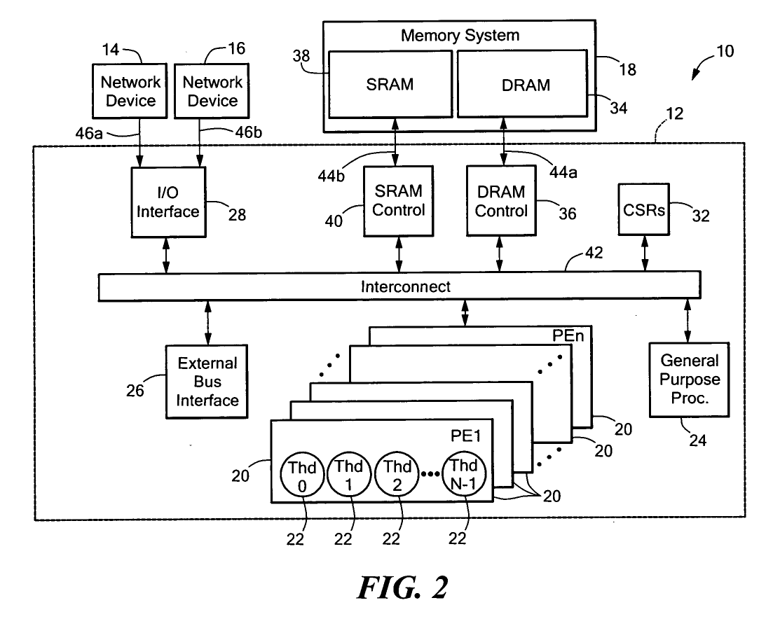

FIG. 2 shows an exemplary system 10 including a processor 12, which can be provided as a network processor. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also be serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

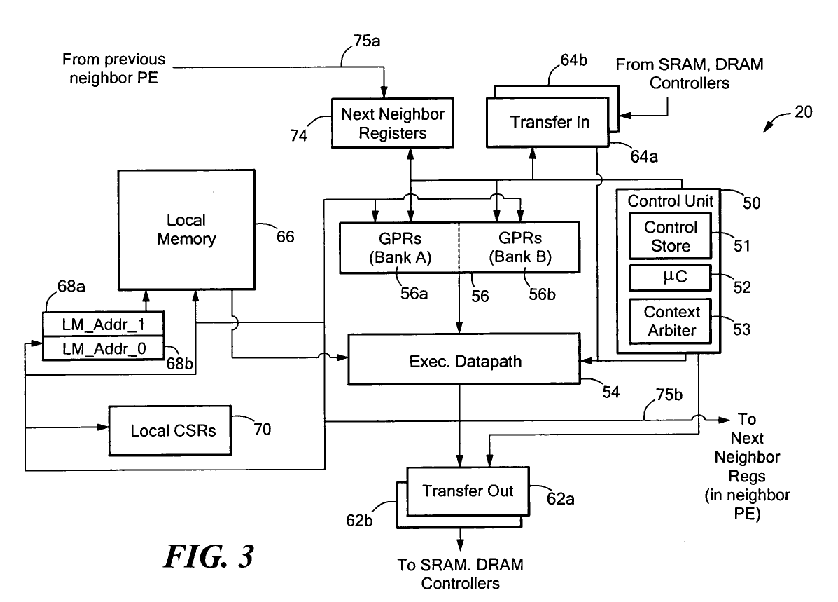

Referring to FIG. 3, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRS) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes a write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

While illustrative hardware is shown and described herein in some detail, it is understood that the exemplary embodiments shown and described herein for efficient memory access for queue control structures are applicable to a variety of hardware, processors, architectures, devices, development systems/tools and the like.

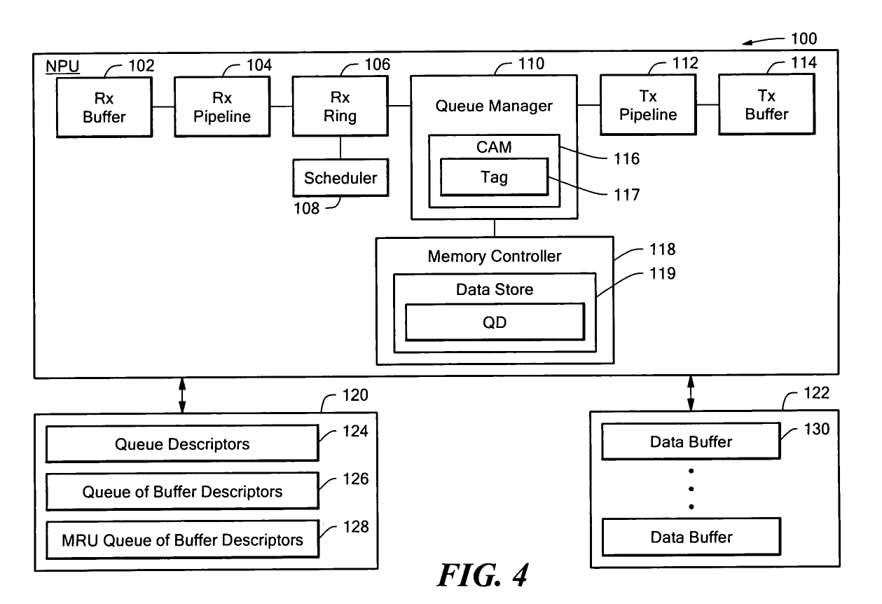

FIG. 4 shows an exemplary NPU 100 receiving incoming data and transmitting the processed data with efficient access of queue data control structures. As described above, processing elements in the NPU 100 can perform various functions. In the illustrated embodiment, the NPU 100 includes a receive buffer 102 providing data to a receive pipeline 104 that sends data to a receive ring 106, which may have a first-in-first-out (FIFO) data structure, under the control of a scheduler 108. A queue manager 110 receives data from the ring 106 and ultimately provides queued data to a transmit pipeline 112 and transmit buffer 114. The queue manager 110 includes a content addressable memory (CAM) 116 having a tag area to maintain a list 117 of tags each of which points to a corresponding entry in a data store portion 119 of a memory controller 118. In one embodiment, each processing element includes a CAM to cache a predetermined number, e.g., sixteen, of the most recently used queue (MRU) descriptors. The memory controller 118 communicates with the first and second memories 120, 122 to process queue commands and exchange data with the queue manager 110. The data store portion 119 contains cached queue descriptors, to which the CAM tags 117 point.

The first memory 120 can store queue descriptors 124, a queue of buffer descriptors 126, and a list of MRU (Most Recently Used) queue of buffer descriptors 128 and the second memory 122 can store processed data in data buffers 130, as described more fully below. The stored queue descriptors 124 can be assigned a unique identifier and can include pointers to a corresponding queue of buffer descriptors 126. Each queue of buffer descriptors 126 can includes pointers to the corresponding data buffers 130 in the second memory 122.

While first and second memories 120, 122 are shown, it is understood that a single memory can be used to perform the functions of the first and second memories. In addition, while the first and second memories are shown being external to the NPU, in other embodiments the first memory and/or the second memory can be internal to the NPU.

The receive buffer 102 buffers data packets each of which can contain payload data and overhead data, which can include the network address of the data source and the network address of the data destination. The receive pipeline 104 processes the data packets from the receive buffer 102 and stores the data packets in data buffers 130 in the second memory 122. The receive pipeline 104 sends requests to the queue manager 10 through the receive ring 106 to append a buffer to the end of a queue after processing the packets. Exemplary processing includes receiving, classifying, and storing packets on an output queue based on the classification.

An enqueue request represents a request to add a buffer descriptor that describes a newly received buffer to the queue of buffer descriptors 126 in the first memory 120. The receive pipeline 104 can buffer several packets before generating an enqueue request.

The scheduler 108 generates dequeue requests when, for example, the number of buffers in a particular queue of buffers reaches a predetermined level. A dequeue request represents a request to remove the first buffer descriptor. The scheduler 108 also may include scheduling algorithms for generating dequeue requests such as “round robin”, priority-based, or other scheduling algorithms. The queue manager 110, which can be implemented in one or more processing elements, processes enqueue requests from the receive pipeline 104 and dequeue requests from the scheduler 108.

In accordance with exemplary embodiments described herein, queue control data structures have a structure that provides efficient memory access when the data structures have a size that is less than a minimum access for memory. For example, while control structures, such as queue descriptors may include 32 bits, the minimum memory access may be 64 bits. An exemplary queue descriptor structure supports blocks and residues that enable efficient queuing for 64-bit accesses for burst-of-4 SRAM and/or DRAM memory having a 16-bit interface, for example. In addition, error correcting codes (ECC) can be used efficiently.

In general, in control memory functions for network processors there is a tradeoff between fine-grain access and increased capacity. Existing high-speed networking applications typically require 32-bit control structures leading to the selection of relatively small access size memory, which are generally limited in capacity. Developing networking applications require increased capacity to support millions of queues and large databases, for example. Larger capacity generally results in a bigger burst size. For a 16-wire interface for example, larger capacity equates to 64-bit minimum access, which can be provided in a burst-of-4 arrangement.

Existing memory technologies typically provide one error/parity check bit per byte. For a 16-wire memory interface having a so-called burst-of-2 architecture, only four error check bits are typically available. To provide single bit error correction for thirty-two bits of data, a minimum of six error-check bits are needed. For 64-bit data, there are eight error check bits available which are sufficient to provide single bit ECC. With increased capacity, the Soft Error Rate (SER) per device is of interest.

In accordance with the exemplary embodiments described herein, a queue data descriptor structure provides a residue mechanism that supports 32-bit data structures in 64-bit memory. The illustrated queue data descriptor eliminates the need for inefficient read-modify-write operations when providing lists of buffers that are accessed as 32-bit operands, when a minimum of 64-bits are read to or written from memory. Using only 64-bit read and write operations also allows ECC support.

While memory accesses are described in conjunction with 32-bit structures and a 64-bit memory access, it is understood that other embodiments include structure having different numbers of bits and memory accesses having larger minimum accesses. Other control structure embodiments and minimum accesses to meet the needs of a particular application will be readily apparent to one of ordinary skill in the art and within the scope of the presently disclosed embodiments.

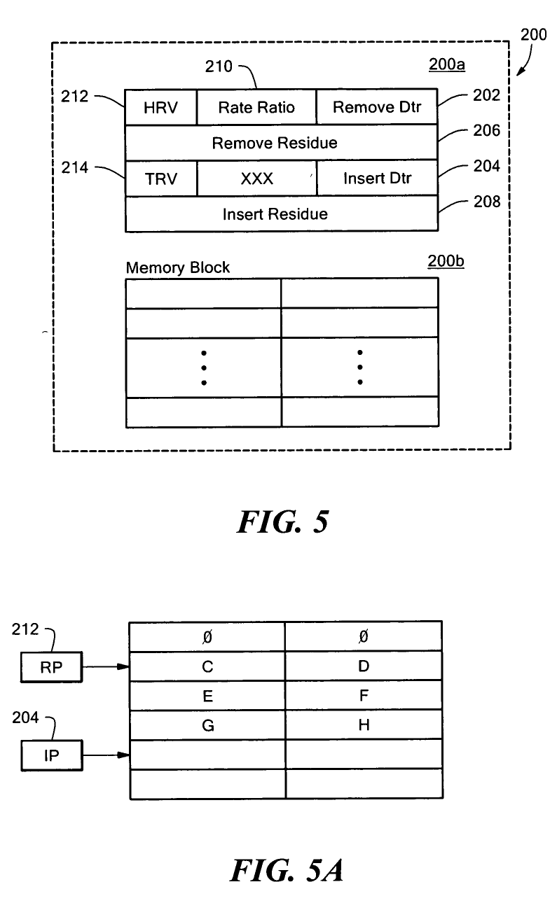

FIG. 5 shows an exemplary queue descriptor 200 having a cache portion 200a and a memory block portion 200b. In an exemplary embodiment, the queue descriptor cache 200a is located onboard the processor and the memory block 200b is external memory. However, other implementations will be readily apparent to one of ordinary skill in the art. The cache 200a includes a remove pointer 202 and an insert pointer 204. The queue descriptor also includes a remove reside 206 and an insert residue 208. In one particular embodiment, the queue descriptor cache 200a structure includes 128 bits, 32 bits for each of the remove residue and the insert residue, and 24 bits for each of the remove pointer 202 and the insert pointer 204. The remaining bits can be used to provide information, such as rate ratio value as well as HRV and TRV values 212, 214.

In general, the insert residue 208 and the remove residue 202 are used to cache the first of two 32-bit operands for an insert entry and the second of two 32-bit operands for a remove entry. As shown in FIG. 5A, the insert pointer 204 points to the next available address in the memory block to store data and the remove pointer 202 points to the address from which the next entries will be removed. When the memory block becomes empty, the block can be assigned to a pool of available memory blocks.

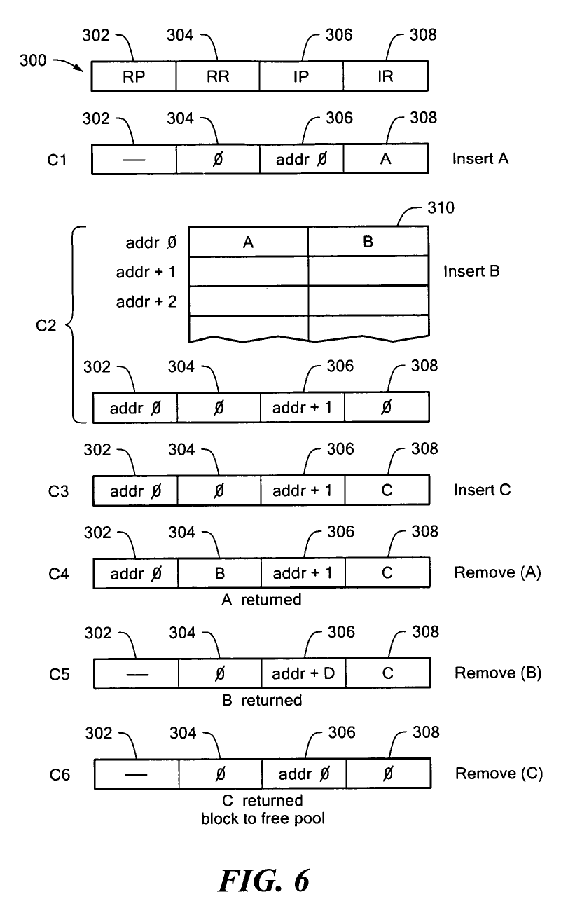

FIG. 6 shows an exemplary sequence of queue descriptor changes associated with inserting and removing packets. It is understood that only the residues and pointers are shown to more readily facilitate an understanding of the exemplary embodiments. A queue descriptor 300 includes a remove pointer 302, a remove residue 304, an insert pointer 306, and an insert residue 308. The queue descriptor initially describes a queue that is empty.

A first command C1 instructs insertion of a first packet into a queue so that a 32-bit value A is stored in the insert residue of the queue descriptor, which corresponds to a buffer descriptor pointing to a data buffer to store the packet data. This eliminates the need to write to a 64-bit minimum access for a 32-bit value for the first packet. A second command C2 instructs the insertion of a second packet (B) into the queue. At this point, a memory block 310 becomes active and the values A, B for the first and second packets are written to the first address addr0 of the queue descriptor memory block 310 in a 64-bit access. The insert pointer 306 now points to the next address addr+1 in the memory block and the residues 304, 308 are empty.

The next command C3 instructs the insertion of a third packet into the queue so that a value C for this packet is placed in the insert residue 308 of the queue descriptor 300. The pointers 302, 306 do not change. An insert packet D command would result in C and D being written to addr+1 and the insert pointer being incremented to addr+2 in the block.

In the next command C4, there is a remove command for the queue. As the first remove command after a write to the block, the remove pointer 302 points to the first memory address addr0, which contains A and B. Since the remove residue 304 is empty, a 64-bit memory access returns value A and stores value B in the remove residue 304 of the queue descriptor. A further remove command C5 returns value B from the remove residue 306 and the queue descriptor now reflects an empty queue and the block can be placed in the pool of free memory blocks.

A further remove command C6 causes packet C, which was cached in the insert residue 308, to be returned. In one embodiment, a count of the insert and/or remove residue is maintained to determine whether a value has been written to memory or not.

Based upon the status of the queue descriptor residues 304, 308, read/write accesses to the memory block 310 are 64-bits. In general, for insert instructions if the insert residue 308 is empty, the new entry is stored in the insert residue word 308 of the queue descriptor. If the insert residue 308 is not empty, 64-bits are written to the buffer block including the insert residue 308 and the new entry, and the insert pointer 306 is incremented to the next 64-bit aligned address.

For remove operations, if the remove residue 304 is empty, a 64-bit read of the buffer block, which can be provided as a FIFO, returns two entries. The first entry of the 64-bits aligned address is returned and the second entry is stored in the remove residue 304 word of the queue descriptor. If the remove residue 304 is not empty, no read of the FIFO structure is required since the desired entry is accessed from the remove residue 304 of the queue descriptor.

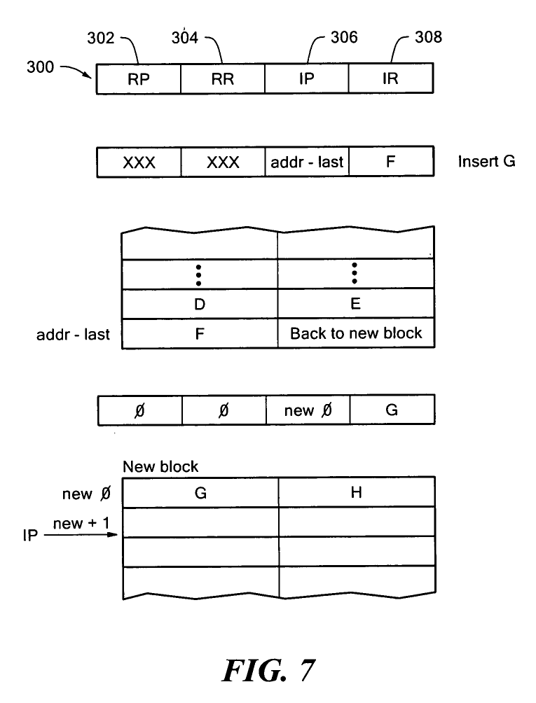

As shown in FIG. 7, when an insert operation is requested, such as insert packet G, and the insert pointer 306 is addressing the last 64-bit aligned location addr_last in a block where the insert residue 308 is not empty, the residue 308, here shown as F, (first 32 bits) and a link (second 32 bits) to a new block are written to the last 64-bit location of the present block. The new insert request G is stored in the insert residue 308. Upon receiving another insert command (e.g., insert H), the insert residue G and packet H are written to the first address new0 of the new block. The insert pointer 306 is then incremented to point to the next address new+1 in the new block.

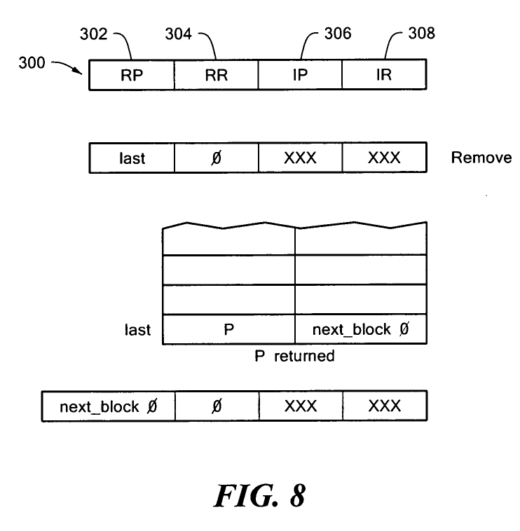

As shown in FIG. 8, when a remove operation is requested and the remove pointer 302 of the queue descriptor 300 is addressing the last 64-bit aligned location of the block (and the remove residue 304 is empty), 64-bits are read with the first 32 bits being the remove entry P, which is returned, and the second 32 bits being the link next_block0 to the next block. The remove pointer 302 is updated with the new link next_block0.

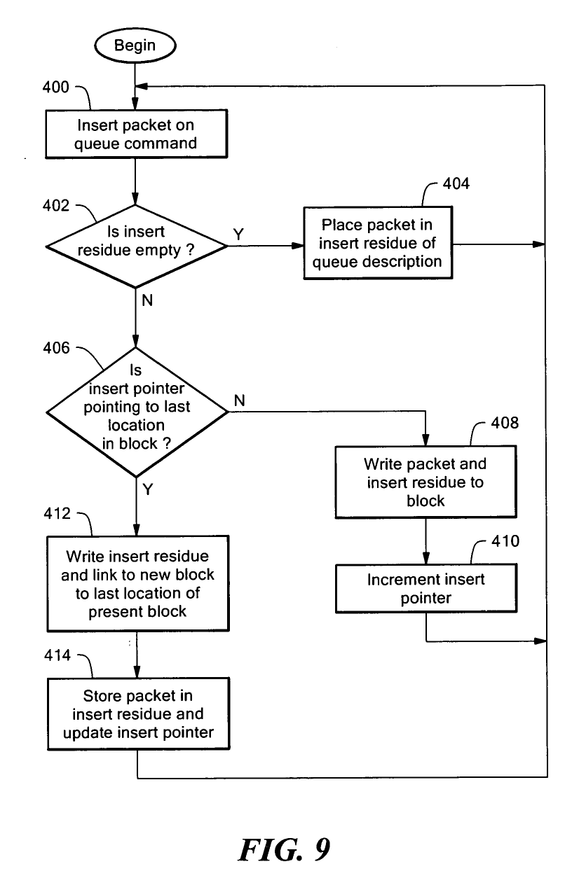

FIG. 9 shows an exemplary sequence of processing blocks to implement queue descriptors with residues and blocks to provide efficient memory access for insert packet commands. In an exemplary embodiment, the insert residue is 32 bits and a memory access is 64 bits. In processing block 400, an insert packet on a queue command is received. In decision block 402, it is determined whether the insert residue of the queue descriptor, such as insert residue 306 in FIG. 6, is empty. If so, the packet is placed in the insert residue of the queue descriptor in processing block 404 and processing continues in block 400. If not, then in processing decision block 406 it is determined whether the insert pointer is pointing to the last location in the buffer block. If not, then the value to be inserted (e.g., A) and the insert residue (e.g., B) are written to the block in processing block 408. In processing block 410 the insert pointer is incremented to point to the next address in the block.

If the insert pointer corresponds to the last location in the buffer block as determined in decision block 406, then in processing block 412 the insert residue and a link to the next block are written to the last location in the current block. In processing block 414, the packet to be inserted is stored in the insert residue of the queue descriptor and the insert pointer is updated to point to the first location in the new buffer block. The next insert commands writes the two values to the first location of the new block.

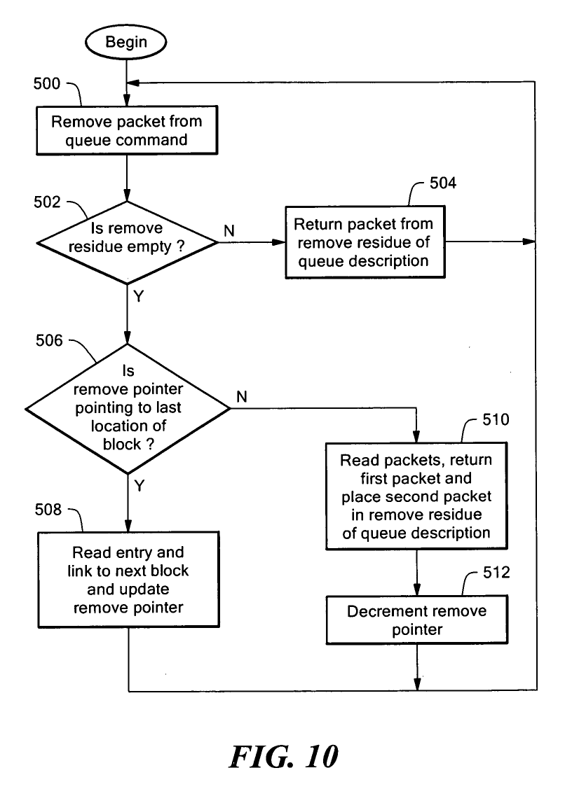

FIG. 10 shows an exemplary implementation of remove command processing that has certain similarities with the inert command processing of FIG. 9. In processing block 500 a remove packet from a queue command is received and in processing decision block 502 it is determined whether the remove residue is empty. If not, in processing block 504 the packet to be removed is returned from the remove residue of the queue descriptor, such as the remove residue 304 of FIG. 6. Processing then continues in block 500.

If the remove residue is empty as determined in decision block 502, it is determined in processing decision block 506 whether the remove pointer is pointing to the last location in the block. If so, in processing block 508 the buffer block is accessed to read the entry (e.g., first 32 bits) and the link to the next block (e.g., second 32 bits) and the remove pointer is decremented to the first address in the next block.

In processing block 510, after it was determined in block 506 that the remove pointer was not pointing to the last location in the buffer block, the block is read (e.g., 64 bits) and the first entry (e.g., 32 bits) is returned the second entry (e.g., 32 bits) is placed in the remove residue of the queue descriptor. In processing block 512 the remove pointer is decremented to point to the next buffer block address and processing continues in block 500.

The presently disclosed embodiments provide a technique to provide efficient 64-bit, for example, memory accesses when using 32-bit, for example, queue control structures. By caching a first 32-bit value until a second 32-bit value is to be read/written to memory, efficient 64-bit accesses are used without costly read-modify-write operations.

Other embodiments are within the scope the appended claims.

What is claimed is:

1. A method of managing a queue, comprising:
receiving a first command to insert a first packet on a queue, wherein the queue is described by a queue descriptor having an insert pointer to point to a first block location, a remove pointer to point to a second block location, an insert residue to store an insert value for the first packet, and a remove residue to store a remove value;
storing the insert value for the first packet in the queue descriptor insert residue when the insert residue is empty;
receiving a second command to insert a second packet on the queue; and
writing the insert value in the insert residue and a value associated with the second packet to the first location in the memory block.

2. The method according to claim 1, further including incrementing the insert pointer to the next location in the memory block.

3. The method according to claim 1, further including determining whether the insert pointer is pointing a last location of the memory block.

4. The method according to claim 1, further including receiving a third command to insert a third packet on the queue and writing an insert value for the third packet into the insert residue.

5. The method according to claim 4, further including receiving a fourth command to remove a packet from the queue and retrieving the values for the first and second packets from the first location in the memory block.

6. The method according to claim 5, further including storing the value for the second packet in the remove residue of the queue descriptor if the remove residue is empty.

7. The method according to claim 5, further including receiving a fifth command to remove a packet from the queue and returning the value for the second packet from the remove residue.

8. The method according to claim 7, further including receiving a sixth command to remove a packet from the queue and returning the value for the third packet from the insert residue.

9. The method according to claim 1, wherein the memory block has a minimum 64-bit access.

10. The method according to claim 1, further including inserting a link to a new memory block in the last location of the memory block.

11. The method according to claim 10, further including incrementing the insert pointer to point to the new memory block.

12. A processing system, comprising:
a queue manager to receive and manage data;
a memory controller coupled to the queue manager;
a memory coupled to the memory controller; and
a queue descriptor having an insert pointer to point to a first block location in the memory, a remove pointer to point to a second block location, an insert residue to store an insert value for the first packet, and a remove residue to store a remove value.

13. The system according to claim 12, wherein the memory includes cache memory and external memory.

14. The system according to claim 12, wherein the first block location is contained within the external memory.

15. The system according to claim 14, wherein the external memory includes a first memory to store the queue descriptor and a second memory to store data buffers.

16. The system according to claim 15, wherein the first memory is SRAM.

17. The system according to claim 15, wherein the second memory is DRAM.

18. The system according to claim 12, wherein the queue manager includes a content addressable memory (CAM) and the memory controller includes cache memory to store the queue descriptor.

19. The system according to claim 12, wherein the queue descriptor is stored in cache memory in the memory controller and further queue descriptors are stored in the memory in external memory.

20. An article comprising:
a storage medium having stored thereon instructions that when executed by a machine result in the following:
managing a queue by:
receiving a first command to insert a first packet on a queue, wherein the queue is described by a queue descriptor having an insert pointer to point to a first block location, a remove pointer to point to a second block location, an insert residue to store an insert value for the first packet, and a remove residue to store a remove value;
storing the insert value for the first packet in the queue descriptor insert residue when the insert residue is empty;
receiving a second command to insert a second packet on the queue; and
writing the insert value in the insert residue and a value associated with the second packet to the first location in the memory block.

21. The article according to claim 20, further including incrementing the insert pointer to the next location in the memory block.

22. The article according to claim 20, further including determining whether the insert pointer is pointing a last location of the memory block.

23. The article according to claim 20, further including receiving a third command to insert a third packet on the queue and writing an insert value for the third packet into the insert residue.

24. The article according to claim 23, further including receiving a fourth command to remove a packet from the queue and retrieving the values for the first and second packets from the first location in the memory block.

25. The article according to claim 24, further including storing the value for the second packet in the remove residue of the queue descriptor if the remove residue is empty.

26. A network forwarding device, comprising:
at least one line card to forward data to ports of a switching fabric, the at least one line card including a network processor having
a queue manager to receive and manage data;
a memory controller coupled to the queue manager;
a memory coupled to the memory controller; and
a queue descriptor having an insert pointer to point to a first block location in the memory, a remove pointer to point to a second block location, an insert residue to store an insert value for the first packet, and a remove residue to store a remove value.

27. The device according to claim 26, wherein the first block location is contained within external memory.

28. The device according to claim 27, wherein the external memory includes a first memory to store the queue descriptor and a second memory to store data buffers.

29. The device according to claim 28, wherein the queue descriptor is stored in cache memory in the memory controller and further queue descriptors are stored in the memory in external memory.
